(19) United States
(12) Patent Application Publication
(10) Pub. No.: US 2023/0420979 A1
(43) Pub. Date: Dec. 28, 2023

(54) INCREASING IMMUNITY OF VARIABLE FREQUENCY DRIVES AGAINST POWER QUALITY ISSUES

(71) Applicant: SAUDI ARABIAN OIL COMPANY, Dhahran (SA)

(72) Inventors: Mohamad W. Yamak, Dhahran (SA); Hashem A. Jaber, Khobar (SA)

(73) Assignee: SAUDI ARABIAN OIL COMPANY, Dhahran (SA)

(21) Appl. No.: 17/809,431

(22) Filed: Jun. 28, 2022

(51) Int. Cl. H02J 9/06; H02J 7/00; H02M 7/06; H02P 27/06

(52) U.S. Cl. CPC H02J 9/06; H02J 7/0013; H02J 7/0063; H02M 7/06; H02P 27/06; H02J 2207/20

(57) ABSTRACT

A system for increasing immunity against power quality problems includes a battery bank configured to supply an uninterruptible power supply (UPS) with direct current (DC) power and a variable frequency drive (VFD). The VFD includes a DC bus with a DC bus voltage, a VFD inverter configured to invert the DC bus voltage to an AC VFD output voltage of a desired frequency, and a rectifier configured to convert an alternating current (AC) supply voltage to the DC bus voltage, and supply the DC bus with the DC bus voltage. The system further includes an electrical connection between the battery bank and the DC bus, the electrical connection configured to provide a supplemental DC current from the battery bank when a DC current provided by the DC bus fails to match a DC current demand by the VFD inverter.

### BACKGROUND

Variable or adjustable Frequency Drives (VFD, AFD) play a vital role in controlling motors in industrial environments, e.g., in the oil and gas industry. The benefits include, but are not limited to a lower inrush current, controllability, and energy savings. However, VFDs tend to be sensitive to power quality issues such as momentary voltage sagging and blackouts. This may be a major limitation in industrial environments in which power quality issues are not uncommon. Operation disruptions and extensive losses may be the result.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a system for increasing immunity against power quality problems, the system including a battery bank configured to supply an uninterruptible power supply (UPS) with direct current (DC) power; a variable frequency drive (VFD) comprising: a DC bus with a DC bus voltage; a VFD inverter configured to invert the DC bus voltage to an AC VFD output voltage of a desired frequency; a rectifier configured to: convert an alternating current (AC) supply voltage to the DC bus voltage, and supply the DC bus with the DC bus voltage; an electrical connection between the battery bank and the DC bus, the electrical connection configured to provide a supplemental DC current from the battery bank when a DC current provided by the DC bus fails to match a DC current demand by the VFD inverter.

In general, in one aspect, embodiments relate to a method for increasing immunity of a variable frequency drive (VFD) against power quality problems, the VFD comprising: a direct current (DC) bus with a DC bus voltage; a VFD inverter configured to invert the DC voltage to an AC VFD output voltage of a desired frequency; a rectifier configured to: convert an alternating current (AC) supply voltage to the DC bus voltage, and supply the DC bus with the DC bus voltage, wherein the DC bus is electrically connected to a battery bank, the battery bank configured to supply an uninterruptible power supply with DC power, the method comprising: in presence of a deterioration of the AC supply voltage, providing a supplemental DC current from the battery bank to the VFD inverter.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows an electrical substation configuration, in accordance with one or more embodiments.

FIG. 2A shows an example of a voltage dip case, in accordance with one or more embodiments.

FIG. 2B shows an example of a short blackout case, in accordance with one or more embodiments.

FIG. 3 shows an integration of a variable frequency drive with electrical substation equipment, in accordance with one or more embodiments.

FIG. 4 shows a flowchart of a method for increasing immunity of variable frequency drives against power quality issues, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments disclosed herein relate to systems and methods for increasing immunity of variable frequency drives (VFDs) against power quality issues. Electrical substations or other types of electric power distribution facilities in industrial or commercial environments may be equipped with switchgear such as disconnect switches, fuses, circuit breakers and other equipment for controlling, protecting, and isolating electrical equipment. In addition, equipment such as uninterruptible power supplies (UPS), battery chargers supplying DC loads, VFDs controlling electric motor speed, etc. may be present.

In one or more embodiments the VFD is configured to rely on an existing battery bank (e.g., batteries of the UPS) to compensate for voltage dips or momentary blackouts to keep the VFD and the motor associated with the VFD operational. The battery bank may, thus, provide backup power to the VFD, at times when the incoming power supply is temporarily compromised. Configurations in accordance with embodiments of the disclosure have various benefits. The availability of power from the battery bank, whenever a voltage dip or other power quality problem is taking place, helps extend the VFD voltage ride-through capability and thereby reduces process interruptions. Further, while many industrial and commercial facilities are equipped with battery banks (e.g., for UPS equipment and battery chargers), these battery banks tend to be expensive and require costly maintenance with finite lifecycles. Frequently, battery banks reach end of service before exploiting all available energy due to temperature or aging resulting in low utilization factor. By interfacing the VFD with a battery bank, the utilization factor increases, thereby making better use of the existing battery bank at a low cost.

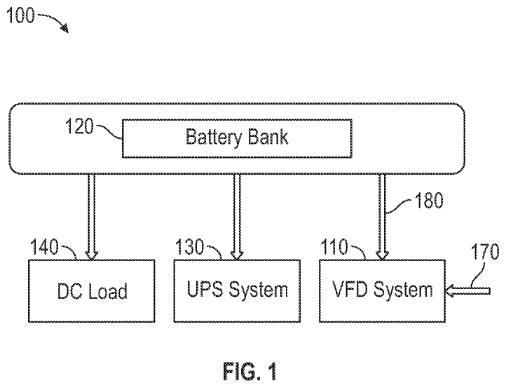

Turning to FIG. 1, an electrical substation configuration, in accordance with one or more embodiments, is schematically shown. The configuration (100) includes a VFD system (110), a battery bank (120), a UPS system (130), and a DC load (140). Each of these components is subsequently described.

The VFD system (110) may drive an electric motor in a controllable manner. The VFD drive system (110) may drive an AC motor. By varying the frequency of the VFD output voltage, the VFD system (110) may control the speed of the AC motor. The operation of the VFD system (110) is discussed in detail below. The VFD system (110) may receive power from a power supply, e.g., an AC power supply (170). The AC power supply (170) may be a commercial or industrial power supply, e.g., a 400V 3-phase AC power supply. The AC power supply (170) may have a different configuration, without departing from the disclosure. For example, the power supply may be single-phase and/or may have any voltage. In one or more embodiments, the VFD system (110) further receives a DC power supply (180), from the battery bank (120). The DC power supply may have any voltage, based on the voltage of the battery bank (120). A detailed discussion of the use of the AC power supply (170) and the DC power supply (180) by the VFD system (110) is provided below.

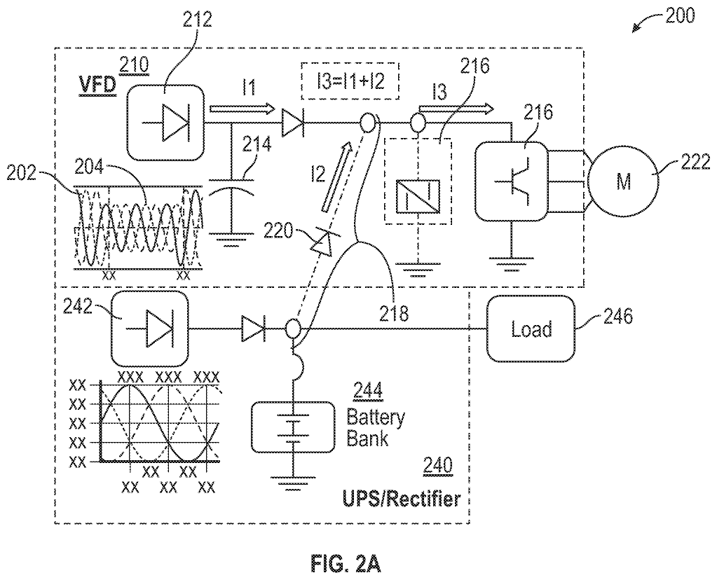

The battery bank (120) may include secondary batteries such as lead-acid, nickel-cadmium, nickel-metal hydride, and/or lithium-ion batteries. Any number of secondary batteries may be combined to provide the desired storage capacity and the desired battery bank voltage. Depending on the size of the battery bank (120), it may be kept in a separate room or a more compact enclosure. The battery bank (120) is designed to provide backup power for various loads that are powered through the UPS system (130) or to DC loads. These loads may include, for example, information technology and/or telecommunication equipment that may, under regular operating conditions, be powered by an AC power supply, and that may be powered via the UPS system (130) upon failure of the AC power supply. The UPS system (130) may include an inverter to convert DC (from the battery bank) to AC, and may further include a rectifier to convert AC (line voltage) to DC. A charger may be included to charge the battery bank (120). Used conventionally, the battery bank (120) may have been designed to primarily or even exclusively provide backup power via the UPS system (130). In such a configuration, the utilization factor of the battery bank (120) may be low. Additionally connected DC loads (140) may slightly increase the utilization factor. By interfacing the VFD with a battery bank, the utilization factor increases, thereby making better use of the existing battery bank. A more detailed discussion of the interaction of various components shown in FIG. 1 is subsequently provided in reference to FIGS. 2A and 2B.

FIGS. 2A and 2B show examples for mitigating a deteriorating quality of the power supply to the VFD, in accordance with one or more embodiments.

Turning to FIG. 2A, an example (200) of a voltage dip case is illustrated. The example (200) includes a VFD (210) and a UPS (240) that are electrically connected by an electrical connection (218).

The VFD (210) includes a rectifier (212) that receives an AC supply voltage (202), e.g., a 3-phase AC voltage as shown, and converts the AC supply voltage into a DC voltage. The DC bus voltage obtained in this manner may be stabilized by a DC bus capacitor (214). A VFD inverter (216) may generate an AC VFD output voltage from the DC bus voltage. The AC VFD output voltage may have three phases and may drive an AC motor (222). By varying the frequency of the AC VFD output voltage, the speed of the AC motor (222) may be modulated. The VFD inverter (216) may include various electronic circuits, including power circuits for generating the AC VFD output voltage and control circuits for controlling the power circuits to generate the AC VFD output voltage at a desired frequency.

The UPS (240) includes a rectifier (242) that receives an AC supply voltage. The AC supply voltage may be the AC supply voltage also supplied to the VFD (210) or a different supply voltage. The rectifier (242) converts the AC supply voltage to a DC voltage suitable for charging the battery bank (244). The DC battery bank voltage may be supplied to a load (246). The load may be a DC load or an inverter configured to generate an AC voltage, e.g., for information technology, instrumentation and/or communication equipment connected to the UPS.

Continuing with the discussion of the VFD (210), during regular operation, a DC current provided by the DC bus (I₁) is sufficient to meet a DC current demand (I₃) by the VFD inverter (216). In other words, I₁=I₃. This may even be the case0 when a very brief voltage dip occurs in the AC supply (202). In this case, the DC bus capacitor (214) may be sufficient to stabilize the DC but voltage. Larger DC bus capacitors may be able to buffer longer and/or more significant voltage drops than smaller DC bus capacitors.

However, when the quality of the AC supply (202) is more significantly compromised (e.g., due to a prolonged and/or more significant voltage drop), this may not be the case. Specifically, FIG. 2A shows a scenario in which a temporary voltage dip (204 occurs in the AC supply (202). As a result of the dip in the AC supply voltage, the DC bus voltage across the capacitor (214) also dips, and the DC current provided by the DC bus (I₁) fails to match the DC current demand (I₃) by the VFD inverter. In one or more embodiments, the electrical connection (218) between the UPS (240) and the VFD (210) enables a supplemental current (I₂) to be provided by the battery bank (244). Under these conditions, the combination of the DC current provided by the DC bus (I₁) and the supplemental current (I₂) to be provided by the battery bank is sufficient to match the DC current demand (I₃). In other words, I₃=I₁+I₂. The contribution of I₂ vs I₁ may be variable. For example, in case of a brief and minor voltage dip (204), the contribution of I₂ may be relatively small, whereas in case of a more significant voltage dip the contribution of I₂ would be larger. In the example (200), the AC supply (202) suffers a voltage drop to 60% of the nominal value while the minimum acceptable drop would be to 80%. In this case the battery bank may compensate 20% to reach the minimum acceptable voltage level.

FIG. 2B shows and example (250) of a momentary blackout (254) of the AC supply (252). In this case, the DC current provided by the DC bus (I₁) may drop to zero. As a result, I3=I2. The existing AC main suffered short black out. In the example (250), the battery bank may compensate 100% of the power for a very short time. The configuration shown in FIG. 2B is otherwise similar to the configuration shown in FIG. 2A.

To prevent a reverse flow of current from the DC bus to the battery bank, the electrical connection (218) may include a blocking diode (220).

To further illustrate the configuration of the examples (200, 250) of FIGS. 2A and 2B, the parameters of the described system may have the following specifications. The system voltage (AC supply (202, 252)) may be 400 VAC. The resulting nominal DC bus voltage may be Vdc=400*sqrt (2)=564 VDC. To support this DC bus voltage, the number of required battery cells may be 564/2.25=250 cells.

Assuming a relatively common industrial system with 240 lead acid cells at 2.25 VDC/cell in series, the DC battery bank voltage may be 240*2.25=540 VDC or 95% of the nominal DC (95% of the 564 VDC). In this case, the battery bank may directly feed into the DC bus of the VFD, without requiring a DC/DC converter such as a buck/boost converter. In the described configuration, the capacity of the battery bank (e.g., measured in watts hours) may determine the time interval of AC supply disruption that may be covered.

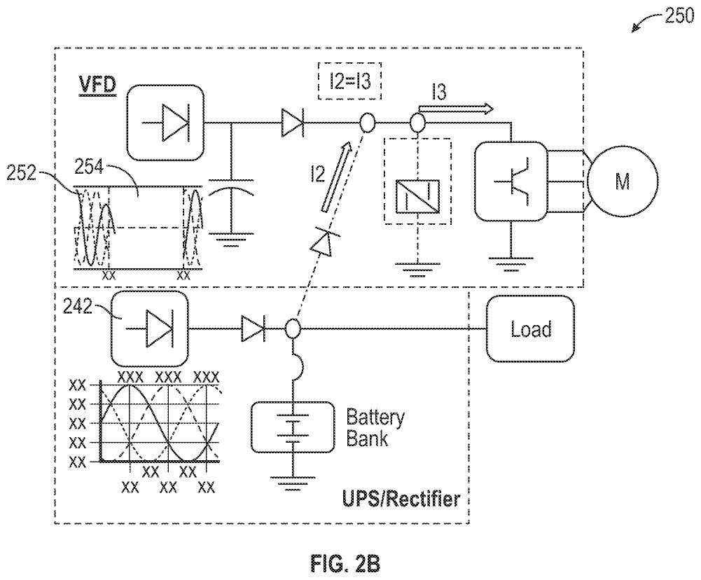

FIG. 3 shows an integration of a VFD with electrical substation equipment, in accordance with one or more embodiments. The example integration (300) includes separate battery and switchgear rooms (380, 390). The battery room (380) with the battery bank (342) may be near or attached to the switchgear room (390). The switchgear room (390) may include a UPS (340) and a VFD (310), as previously described. The embodiment shown in FIG. 3 further includes a charger (344) and a buck/boost converter (350). The charger (344) may charge the battery bank (342). A buck converter may be used to lower the DC voltage if the DC battery bank voltage is higher than the DC bus voltage. A boost converter may be used to increase the DC voltage if the DC battery bank voltage is lower than the DC bus voltage.

While FIGS. 1, 2A, 2B, and 3 show various configurations of components, other configurations may be used without departing from the scope of the disclosure. For example, various components may be combined to create a single component. As another example, the functionality performed by a single component may be performed by two or more components.

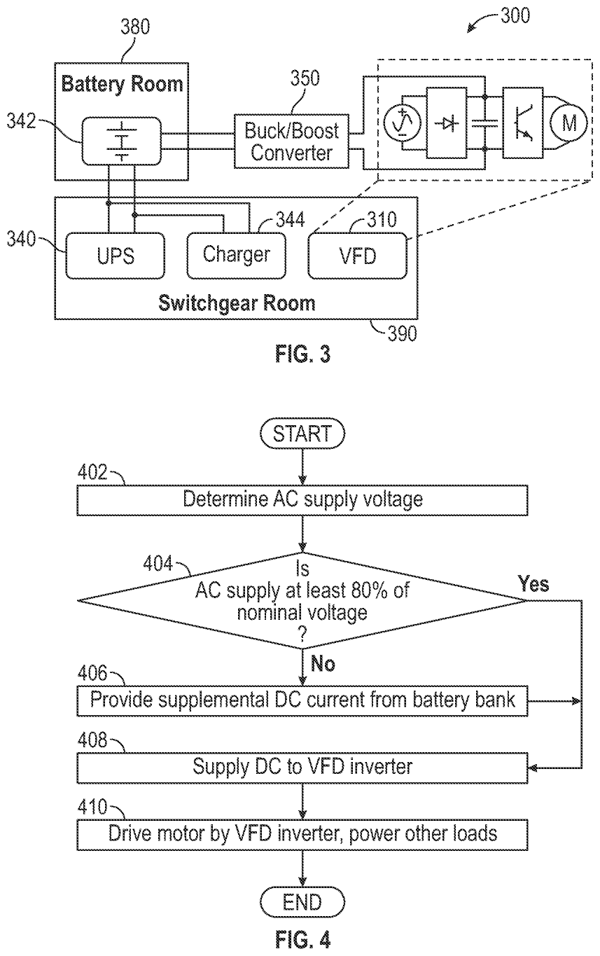

Turning to FIG. 4, a flowchart in accordance with one or more embodiments is shown. The flowchart describes a method for increasing immunity of VFD drives against power quality issues. One or more blocks in FIG. 4 may be performed using a system as described in FIGS. 1, 2A, 2B, and 3. While the various blocks in FIG. 4 are presented and described sequentially, one of ordinary skill in the art will appreciate that some or all of the blocks may be executed in different orders, may be combined or omitted, and some or all of the blocks may be executed in parallel.

In Block 402, an AC supply voltage is determined. The AC supply voltage being determined is the AC supply voltage present at the input of the VFD.

In Block 404, if the AC supply voltage is less than 80% of the nominal AC supply voltage, in Block 406 a supplemental DC current is provided from the battery bank to the VFD inverter of the VFD, in addition to the current being provided by the rectified AC supply. A boost conversion may be performed to increase the DC battery bank voltage. A buck conversion may be performed to lower the DC battery bank voltage. If the AC supply voltage is greater than 80% of the nominal AC supply voltage, no supplemental DC current is provided because the VFD may drive the AC motor without interruption in presence of an AC supply voltage that is 80% of the nominal AC supply voltage.

In Block 408, the DC supply is provided to the VFD inverter.

In Block 410, the AC motor is driven by the VFD inverter. The frequency of the VFD inverter output may be modulated to control the speed of the AC motor.

Embodiments disclosed herein provide long time ride-through covering power and control aspects in the same facility where AFD is needed, thereby increasing the overall system efficiency. Further, embodiments disclosed herein reduce mean time between failure of AFD by enhancing the ride-through capabilities, and results in reduction of production losses in the oil and gas industry.

Embodiments of the disclosure may be used in many different environments and for many different applications. Broadly speaking, embodiments of the disclosure may be used in any environment, e.g., in the oil and gas or other industries where equipment such as VFDs, UPS systems, charger systems, etc. are used. The VFD may be used for an electrical submersible pump (ESP), or any other system or device that includes an AC motor.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for increasing immunity against power quality problems, the system comprising:
a battery bank configured to supply an uninterruptible power supply (UPS) with direct current (DC) power;
a variable frequency drive (VFD) comprising:
a DC bus with a DC bus voltage;
a VFD inverter configured to invert the DC bus voltage to an AC VFD output voltage of a desired frequency;
a rectifier configured to:
convert an alternating current (AC) supply voltage to the DC bus voltage, and
supply the DC bus with the DC bus voltage;
an electrical connection between the battery bank and the DC bus, the electrical connection configured to provide a supplemental DC current from the battery bank when a DC current provided by the DC bus fails to match a DC current demand by the VFD inverter.

2. The system of claim 1, wherein the electrical connection comprises a blocking diode.

3. The system of claim 1, wherein the electrical connection comprises a buck converter.

4. The system of claim 1, wherein the electrical connection comprises a boost converter.

5. The system of claim 1, where the battery bank is further configured to supply a DC load with the DC power.

6. The system of claim 1, further comprising a charger configured to charge the battery bank.

7. The system of claim 1, further comprising an AC motor driven by the VFD inverter.

8. The system of claim 7, wherein the AC motor is for machinery in the oil and gas industry.

9. The system of claim 7, wherein the AC motor is for an electrical submersible pump.

10. A method for increasing immunity of a variable frequency drive (VFD) against power quality problems,
the VFD comprising:
a direct current (DC) bus with a DC bus voltage;
a VFD inverter configured to invert the DC voltage to an AC VFD output voltage of a desired frequency;
a rectifier configured to:
convert an alternating current (AC) supply voltage to the DC bus voltage, and
supply the DC bus with the DC bus voltage,
wherein the DC bus is electrically connected to a battery bank, the battery bank configured to supply an uninterruptible power supply with DC power,
the method comprising:
in presence of a deterioration of the AC supply voltage beyond VFD ride-through capabilities, providing a supplemental DC current from the battery bank to the VFD inverter.

11. The method of claim 10, further comprising:
in absence of the deterioration of the DC supply voltage, entirely supplying the VFD inverter from the DC bus.

12. The method of claim 10, further comprising:
in absence of the deterioration of the DC supply voltage, blocking a reverse DC current from the DC bus to the battery bank using a blocking diode.

13. The method of claim 10, wherein the deterioration is a voltage dip of the AC supply voltage.

14. The method of claim 10, wherein the deterioration is a momentary blackout of the AC supply voltage.

15. The method of claim 10, wherein the supplemental DC current combined with a DC current provided by the DC bus matches a DC current demand by the VFD inverter.

16. The method of claim 10, wherein providing the supplemental DC current from the battery bank to the VFD inverter comprises buck-converting from a DC voltage of the battery bank to the DC bus voltage.

17. The method of claim 10, wherein providing the supplemental DC current from the battery bank to the VFD inverter comprises boost-converting from a DC voltage of the battery bank to the DC bus voltage.

18. The method of claim 10, further comprising charging the battery bank.
